(19) United States
(12) Patent Application Publication
(10) Pub. No.: US 2009/0055738 A1
(43) Pub. Date: Feb. 26, 2009

(54) Techniques for Providing Dynamic Help Content for a Command Line Interface

(76) Inventors: Mario F. Acedo, Tucson, AZ (US); Ezequiel Cervantes, Tucson, AZ (US); Paul A. Jennas, II, Tucson, AZ (US); Jason Peipelman, Vail, AZ (US); Matthew J. Ward, Vail, AZ (US)

Correspondence Address: DILLON & YUDELL, LLP, 8911 N CAPITAL OF TEXAS HWY, SUITE 2110, AUSTIN, TX, 78759, US

(21) Appl. No.: 11/844,113

(22) Filed: Aug. 23, 2007

(51) Int. Cl. G06F 3/00

(52) U.S. Cl. 715/708

(57) ABSTRACT

A technique for providing assistance to a user of a system includes receiving a current command entered into a command line interface of the system and determining a current state of a system. Command help for the current command is then generated based on the current state of the system.

### BACKGROUND

1. Field

This disclosure relates generally to a command line interface and, more specifically to techniques for providing dynamic help content for a command line interface.

2. Related Art

A command line interface (CLI) provides a method of interacting with an operating system or other software using a command line interpreter, which may be a text terminal, a terminal emulator, or remote shell client. A CLI is typically used when a large vocabulary of commands or queries, coupled with a wide range of options, can be entered more rapidly as text than with a pure graphical user interface (GUI). CLIs are often used by programmers and system administrators (e.g., in engineering and scientific environments) and by technically advanced personal computer users. A CLI can generally be considered as consisting of syntax and semantics. The syntax is the grammar that all commands must follow. In the case of operating systems (OSs), each OS defines its own set of rules that all commands must follow. In the case of embedded systems, each vendor defines their own proprietary set of rules to which all commands within their CLI conform. In general, the rules also dictate how a user navigates through the system of commands and the semantics define what sort of operations are possible, and on what sort of data these operations can be performed. A relatively simple CLI usually displays a prompt to accept a command line that is typed by a user and terminated by an enter key.

Upon executing an entered command, a relatively simple CLI usually provides a textual display of a result (or an error message). Advanced CLIs usually validate, interpret and parameter-expand the command line before executing the specified command, and optionally capture or redirect its output. Unlike a button or menu item in a GUI, a command line is typically self-documenting, stating exactly what the user wants done. In addition, command lines usually include many defaults that can be changed to customize the results. Useful command lines can usually be saved by assigning a character string or alias to represent the full command, or several commands can usually be grouped to perform a more complex sequence, which creates a single entity called a command procedure or script which itself can be treated as a command.

In some CLIs, the commands issued are not coupled to any conceptual place within a command hierarchy. In this case, a user can specify relative or absolute paths to any command or data. Following this approach, resource protection is typically achieved by assigning resource ownership to privileged groups, and password-protecting user accounts which may be members of specific groups. Other CLIs (such as those employed in conjunction with routers) may limit the set of commands that a user can perform to a subset of commands which is determined by a location within a command hierarchy, e.g., grouped by association with security, a system, an interface, etc. The location within this hierarchy and the options available are often referred to as a mode. In such systems, a user might traverse through a series of sub-hierarchies, each with their own subset of commands. For example, if the CLI includes an interface mode and a system mode, a user may enter the word ‘interface’ at a command prompt (i.e., a sequence of one or more characters used in a CLI to indicate readiness to accept commands) to enter the interface mode, where a predetermined subset of commands and data are available. In this case, system commands are not accessible until the user explicitly exits the interface mode.

CLIs for many products have become relatively complex. For example, CLIs for storage products have become increasingly complex in order to manage a relatively large number of object resources and resource states. In general, help tools for CLIs of storage products have attempted to assist users in configuring and maintaining the storage products. Unfortunately, help tools for CLIs of storage products have frequently provided overly generic command examples that may not be valid for a current state of a storage product.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 is a block diagram of an example storage system that employs a command line interface that may be configured to provide assistance to a user of the system, according to various embodiments of the present disclosure.

FIG. 2 is a flowchart of an example process for providing command help to a user of the system of FIG. 1, according to one embodiment of the present disclosure.

FIG. 3 is a example screen dump that provides command help in the form of a warming.

### DETAILED DESCRIPTION

As will be appreciated by one of ordinary skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but is not limited to, an electronic, magnetic, optical, electromagnetic, infrared, or semiconductor system, apparatus, device. More specific examples (a non-exhaustive list) of the computer-readable medium would include the following: a portable computer diskette, a hard disk a random access memory (RAM), a read-only memory (ROM), an erasable programmable read-only memory (EPROM or Flash memory), an optical fiber, a portable compact disc read-only memory (CD-ROM), an optical storage device, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain or store the program for use by or in connection with an instruction execution system, apparatus, or device.

Computer program code for carrying out operations of the present invention may be written in an object oriented programming language, such as Java, Smalltalk, C++, etc. However, the computer program code for carrying out operations of the present invention may also be written in conventional procedural programming languages, such as the “C” programming language or similar programming languages. The program code may execute entirely on a single computer, on multiple computers that may be remote from each other, or as a stand-alone software package. When multiple computers are employed, one computer may be connected to another computer through a local area network (LAN) or a wide area network (WAN), or the connection may be, for example, through the Internet using an Internet service provider (ISP).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks. As used herein, the term “coupled” includes both a direct electrical connection between blocks or components and an indirect electrical connection between blocks or components achieved using intervening blocks or components.

According to one aspect of the present disclosure, a technique for providing assistance to a user of a system includes receiving a current command entered into a command line interface (CLI) of the system and determining a current state (configuration) of a system. In a typical case, the user indicates (to the system) that the user desires dynamic help by entering an appropriate text string (e.g., ‘-dhelp’) in conjunction with the current command. Alternatively, dynamic help may be indicated in other manners (e.g., by placing the CLI in a help mode). Command help (in graphical or text form) for the current command is then generated based on the current state of the system. When the command help is provided in graphical form, the user of the system may select an example (included within the command help) for execution by, for example, double clicking on the example using a mouse.

According to another aspect of the present disclosure, a storage system is disclosed that includes a display and a processor that is coupled to the display. The processor is configured to receive a current command entered into a command line interface of the storage system and determine a current state (configuration) of the storage system. Command help (in graphical or text form) for the current command is then generated based on the current state of the storage system.

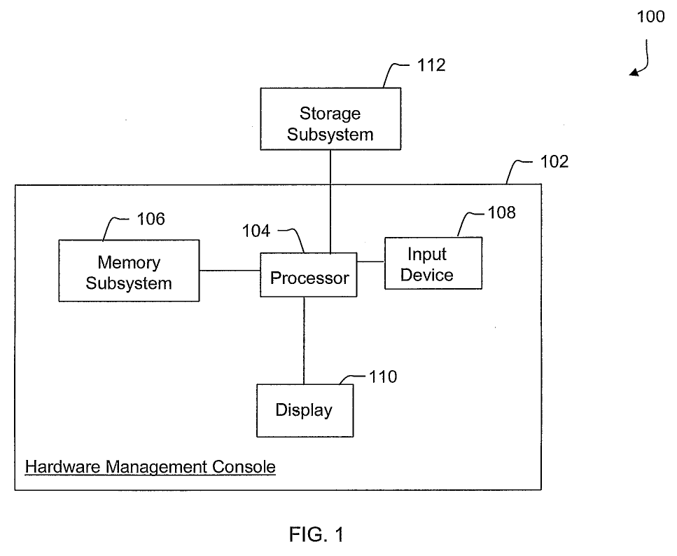

With reference to FIG. 1, an example storage system 100 (e.g., a DS8000 series system storage manufactured and made commercially available by IBM Corp.) is illustrated that may be configured to include a help application (e.g., stored in memory subsystem 106) that is configured to provide dynamic assistance to a user according to the present disclosure. As is shown, the system 100 includes a hardware management console (HMC) 102 that is coupled to a storage subsystem (product) 112. The help application may be locally stored on the HMC (computer system) 102 or stored on a different computer system (e.g., a computer system that is included as part of the storage subsystem 112). The help application may, for example, execute within a same Java virtual machine (JVM) as a command line interface (CLI) application or execute within a different JVM. The storage subsystem 112 may include, for example, multiple servers, multiple redundant array of inexpensive disks (RAID) subsystems, etc.

As is illustrated, the HMC 102 includes a processor 104 (including one or more central processing units (CPUs)) that is coupled to the memory subsystem 106 (which includes an application appropriate amount of volatile and non-volatile memory), an input device 108 (e.g., a keyboard and a mouse), and a display 110 (e.g., a cathode ray tube (CRT) or a liquid crystal display (LCD)). The HMC 102 may be utilized, for example, by an administrator that is attempting to setup, maintain, or troubleshoot operation of the storage subsystem 112. The processor 104 of the HMC 102 is in communication with the storage subsystem 112 and receives input from a user via a command line interface (CLI) provided via the display 110. Alternatively, the management console may be incorporated within the storage subsystem 112 or within an other system or subsystem. While the techniques disclosed herein are discussed in conjunction with a storage system, it is contemplated that the techniques are broadly applicable to the configuration of hardware (e.g., network hardware) using a CLI. The techniques disclosed herein generally increase the usability of a system and educate a user of the system as to proper command syntax and semantics.

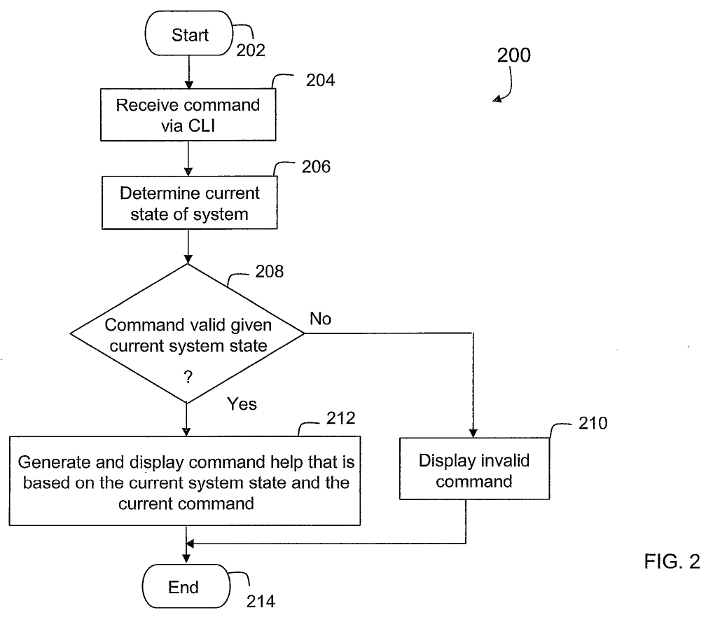

Moving to FIG. 2, an example process 200 for providing assistance to a user of a system, e.g., the storage system 100, is illustrated. In block 202, the process 200 is initiated at which point control transfers to block 204. In block 204, a command line interpreter receives an incoming command (which may include a request for dynamic help in conjunction with the command) via a command line interface (CLI). Next, in block 206, a current state (configuration) of the system is determined. Then, in block 208, it is determined whether the entered command is valid given the current state of the system. If the command is not valid given the current state of the system in block 208, control transfers to block 210.

In block 210, a warning is displayed to a user that indicates that the entered command is invalid given the current state of the system and that a usable list of dynamic examples cannot be generated. The warning may, for example, be provided to the user via a pop-up graphical user interface (GUI) web page. If the command is valid given the current state of the system in block 208, control transfers to block 212. In block 212, command help that is based on the current state of the system and the current command is generated and displayed, via, for example, a pop-up GUI web page. The user may then enter the command in an appropriate manner into the CLI. Alternatively, the user may select an example from the pop-up GUI web page for execution. The command help may include, for example, proper syntax and semantics for the current command, as well as appropriate ranges for command parameters of the current command based on the current system state. Following blocks 210 and 212, control transfers to block 214 where the process 200 returns to a calling process.

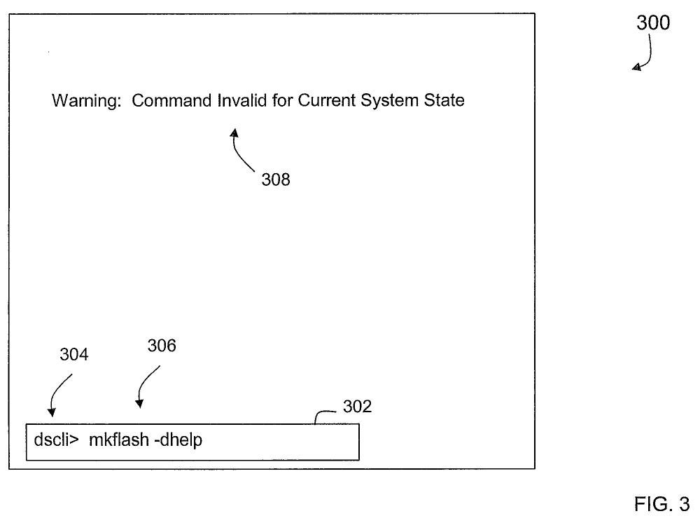

Turning to FIG. 3, an example display 300 is depicted that illustrates various aspects of the present disclosure. The display 300 includes a CLI 302 that depicts a prompt 304 (i.e., dscli>) and an entered command string 306 (i.e., ‘mkflash-dhelp’). Responsive to the command string 306, the system provides a warning 308 to the user advising that the command ‘mkflash’ (which initiates a point-in-time copy from source volumes to destination volumes) is invalid for the current system state. The warning may be generated, for example, following system determination of a volume count for all existing logical subsystems (LSSs) when less than two volumes are in a usable state. On the other hand, assuming that more than two volumes are in a usable state, a generated list may be provided that includes usable volume ranges and allowed source/target pairs (determined by volume size, where source size is less than target size), etc. In this case, various option possibilities (count key data (CKD) or fixed block (FB), volume size, etc.), which are based on a current volume configuration, may also be displayed. It should be appreciated that command help may be displayed in a text format in the same screen as the CLI 302, in the CLI 302, or may be provided in a different screen (which may, for example, correspond to a pop-up GUI web page). Accordingly, techniques have been disclosed herein that readily facilitate providing assistance to a user of a system that employs a command line interface.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method of providing assistance to a user of a system, comprising:
receiving a current command entered into a command line interface of the system;
determining a current state of the system; and
generating command help for the current command based on the current state of the system.

2. The method of claim 1, further comprising:
displaying the generated command help.

3. The method of claim 2, wherein the generated command help includes a partially completed command that corresponds to the current command with ranges that are based on the current state of the system.

4. The method of claim 1, wherein the system is a storage system.

5. The method of claim 1, the generating further comprises:
generating help text based on the current state of the system when a help option is entered into the command line interface in conjunction with the current command.

6. A storage system, comprising:
a display; and
a processor coupled to the display, wherein the processor is configured to:
determine a current command entered into a command line interface of the storage system;
determine a current state of the storage system; and
generate command help for the current command based on the current state of the storage system.

7. The storage system of claim 6, wherein the processor is further configured to:
display the generated command help.

8. The storage system of claim 7, wherein the generated command help includes a partially completed command corresponding to the current command with ranges that are based on the current state of the system.

9. The storage system of claim 6, the processor is further configured to generate help text based on the current state of the system when a help option is entered into the command line interface in conjunction with the current command.
